(19) United States
(12) Patent Application Publication
(10) Pub. No.: US 2023/0346055 A1
(43) Pub. Date: Nov. 2, 2023

(54) MASK CAPABLE OF BLOCKING AIR FLOWS BETWEEN MOUTH AND NOSE

(71) Applicant: Wenbin MAO, Shangrao (CN)

(72) Inventor: Wenbin MAO, Shangrao (CN)

(21) Appl. No.: 17/837,007

(22) Filed: Jun. 9, 2022

(30) Foreign Application Priority Data
Apr. 27, 2022 (CN) 2022209948387

(51) Int. Cl. A41D 13/11; A62B 7/10

(52) U.S. Cl. CPC A41D 13/1107; A41D 13/1161; A62B 7/10; A41D 2400/38

(57) ABSTRACT

A mask capable of blocking air flows between the mouth and nose, relates to the field of personal hygiene protective articles and includes a mask body. Left and right ends of the mask body are fixedly connected with ear ropes. A rear surface of the mask body is fixedly connected with a blocking sheet. A tightening rope penetrates transversely through an inner cavity of the mask body, and is arranged on an upper side of the blocking sheet. A nose bridge strip is fixedly connected in the inner cavity of the mask body. The mask can provide a blocking between the mouth and the nose through the blocking sheet and press tightly through the tightening rope to prevent peculiar smell emitted from the mouth from flowing into a nasal cavity when a user wears the mask, and thus comfort of the user wearing the mask can be improved.

### TECHNICAL FIELD

The disclosure relates to the field of personal hygiene protective articles, and more particularly to a mask capable of blocking air flows between a mouth and a nose.

### BACKGROUND

A mask (also referred to as respirator) is a kind of sanitary product, which is generally used to filter air entering the mouth and nose by wearing it on the mouth and nose, so as to play a role of blocking harmful gases, smells, droplets, viruses and other substances. It is made of gauze or paper, etc. The mask has a certain filtering effect on the air entering lungs, and when respiratory infectious diseases are prevalent and when working in dust and other polluted environments, wearing a mask would have a very good effect.

At present, in order to improve the comfort of users, a rear surface of a mask on the market is usually designed to be relatively flat, so that there is a lack of barrier between the mouth and the nose of the user, and when a user wears the mask after eating some pungent food or when a user with halitosis wears the mask, the user can usually smell the peculiar smell emitted from the mouth, so that the user is uncomfortable when wearing the mask. In addition, when a myopic people wear the mask in winter, hot air exhaled by the myopic person would flow to the glasses along a gap between the nose bridge and the mask, causing blurred vision and inconvenient use. In view of the above defects, the inventors propose a mask capable of blocking air flows between the mouth and the nose.

### SUMMARY

### 1. Technical Problem to be Solved

Aiming at the problems existing in the prior art, a purpose of the invention is to provide a mask capable of blocking air flows between a mouth and a nose, which can provide a blocking between the mouth and the nose through a blocking sheet and press tightly through a tightening rope to prevent the peculiar smell emitted from the mouth from flowing into a nasal cavity when a user wears the mask, and thus the comfort of the user wearing the mask can be improved. Moreover, by setting a sealing strip, a sealing between the mask and the nose bridge when wearing the mask can be enhanced, so that the exhaled hot air can be prevented from flowing to glasses worn by a user wearing the mask, and a usage experience of a myopic person wearing the mask in winter can be improved.

### 2. Technical Solutions

in order to solve the above-mentioned problems, embodiments of the invention propose solutions as follows.

A mask capable of blocking air flows between a mouth and a nose may include a mask body, left and right ends of the mask body are fixedly connected to a pair of ear ropes, a rear surface of the mask body is fixedly connected with a blocking sheet, a tightening rope penetrates transversely through an inner cavity of the mask body, the tightening rope is arranged on an upper side of the blocking sheet, a nose bridge strip is fixedly connected in the inner cavity of the mask body, the nose bridge strip is arranged on an upper side of the tightening rope, and a shaping sheet is fixedly connected in an inner cavity of the blocking sheet. This technical solution can provide a blocking between the mouth and the nose through the blocking sheet and press tightly through the tightening rope to prevent peculiar smell emitted from the mouth from flowing into a nasal cavity when a user wears the mask, and thus the comfort of the user wearing the mask can be improved. Moreover, by setting a sealing strip, a sealing between the mask and the nose bridge when wearing the mask can be enhanced, so that exhaled hot air can be prevented from flowing to glasses worn by the user, and a usage experience of a myopic person wearing the mask in winter can be improved.

In an embodiment, the shaping sheet is made of an aluminum alloy material. The shaping sheet made of the aluminium alloy material is convenient to bend, and when the mask is worn, the mask can be bent along a crease, and the blocking sheet is shaped by bending the shaping sheet, so that the blocking sheet is tightly attached to the upper lip of a user, good blocking between the mouth and the nose can be achieved, and air flows between the mouth and the nose can be avoided consequently.

In an embodiment, the rear surface of the mask body is fixedly connected with a sealing strip, the sealing strip is arranged on an upper side of the nose bridge strip, and the sealing strip is made of a slow-rebound sponge material. By setting the sealing strip made of slow-rebound sponge material, a degree of fitting between the mask and a nose bridge can be improved when wearing the mask, and when wearing the mask in winter, exhaled hot air can be prevented from flowing to the glasses worn by the user, which can improve the usage experience of a myopic person wearing the mask in winter.

In an embodiment, the mask body is made of a non-woven fabric and a filter paper material. By setting the mask body made of the non-woven fabric and the filter paper material, the mask body may have certain air permeability while blocking germs and droplets.

### 3. Beneficial Effect

Compared with the prior art, embodiments of the invention may have advantages as follows.
(1) the invention can provide a blocking between the mouth and the nose through the blocking sheet and press tightly through the tightening rope to prevent peculiar smell emitted from the mouth from flowing into a nasal cavity when a user wears the mask, and thus comfort of the user wearing the mask can be improved. Moreover, by setting the sealing strip, a sealing between the mask and the nose bridge when wearing the mask can be enhanced, so that exhaled hot air can be prevented from flowing to glasses worn by the user, and a usage experience of a myopic person wearing the mask in winter can be improved.
(2) the shaping sheet is made of the aluminum alloy material. The shaping sheet made of the aluminium alloy material is convenient to bend, and when the mask is worn, the mask can be bent along a crease, and the blocking sheet is shaped by bending the shaping sheet, so that the blocking sheet is tightly attached to an upper lip of a user, good blocking between the mouth and the nose can be achieved, and air flows between the mouth and the nose can be avoided consequently.
(3) the rear surface of the shaping sheet is provided with a crease, and the crease is located at a quarter position and at a lower end of the shaping sheet. By setting the crease, it is convenient to bend the shaping sheet.
(4) the rear surface of the mask body is fixedly connected with the sealing strip, the sealing strip is arranged on the upper side of the nose bridge strip, and the sealing strip is made of the slow-rebound sponge material. By setting the sealing strip made of the slow-rebound sponge material, a degree of fitting between the mask and the nose bridge can be improved when wearing the mask, and when wearing the mask in winter, exhaled hot air can be prevented from flowing to glasses worn by the user, which can improve the usage experience of a myopic person wearing the mask in winter.
(5) the mask body is made of the non-woven fabric and the filter paper material. By setting the mask body made of the non-woven fabric and the filter paper material, the mask body may have certain air permeability while blocking germs and droplets.

### BRIEF DESCRIPTION OF DRAWINGS

FIG. 1 illustrates a schematic view of an overall structure of a mask according to an embodiment of the invention.

FIG. 2 illustrates a schematic view of a rear structure of the mask according to an embodiment of the invention.

FIG. 3 illustrates a schematic cross-sectional rear view of an internal structure of the mask according to an embodiment of the invention.

FIG. 4 illustrates a schematic cross-sectional side view of the internal structure of the mask according to an embodiment of the invention.

FIG. 5 illustrates a schematic enlarged view of a portion A in FIG. 4 according to an embodiment of the invention.

FIG. 6 illustrates a schematic view of a shaping sheet according to an embodiment of the invention.

### DESCRIPTION OF NUMERAL REFERENCES

1. mask body; 2. ear rope; 3. blocking sheet; 4. tightening rope; 5. nose bridge strip; 6. shaping sheet; 7. crease; 8. sealing strip.

### DETAILED DESCRIPTION OF EMBODIMENTS

Technical solutions of embodiments of the invention will be clearly and completely described below with reference to the accompanying drawings in the embodiments of the invention. Apparently, the described embodiments are only some of embodiments of the invention, rather than all of embodiments of the invention. Based on the described embodiments of the invention, all other embodiments obtained by those skilled in the art without creative effort should belong to the scope of protection of the invention.

In the description of embodiments of the invention, it should be noted that orientations or positional relationships indicated by terms “upper”, “lower”, “internal”, “external”, “top/bottom” and so on are based on the orientations or positional relationships shown in the accompanying drawings, and only for the convenience of describing the embodiments of the invention and simplifying the description, rather than indicating or implying that the indicated device or element must have a specific orientation, be constructed and operated in a specific orientation, and therefore cannot be construed as limiting the invention. In addition, terms such as “first” and “second” are used only for descriptive purposes and cannot be construed as indicating or implying relative importance.

In the description of embodiments of the invention, it should be noted that unless otherwise expressed specified and limited, terms “mounted”, “arranged”, “sleeved”, “connected” and so on should be understood in a broad sense. For example, “connected” can be a fixed connection, a detachable connection, or an integral connection (one-piece connection), it can be a mechanical connection or an electrical connection, it can be a direct connection or an indirect connection through an intermediate medium, or can be an inner communication between two components. For those skilled in the art, specific meanings of the above terms in the invention can be understood in specific circumstances.

### EMBODIMENTS

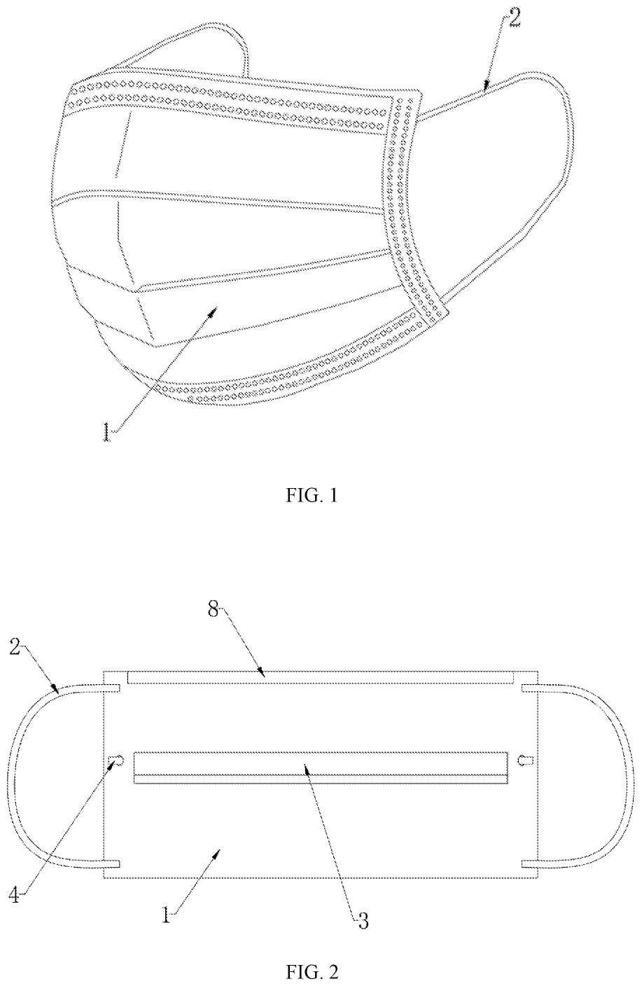

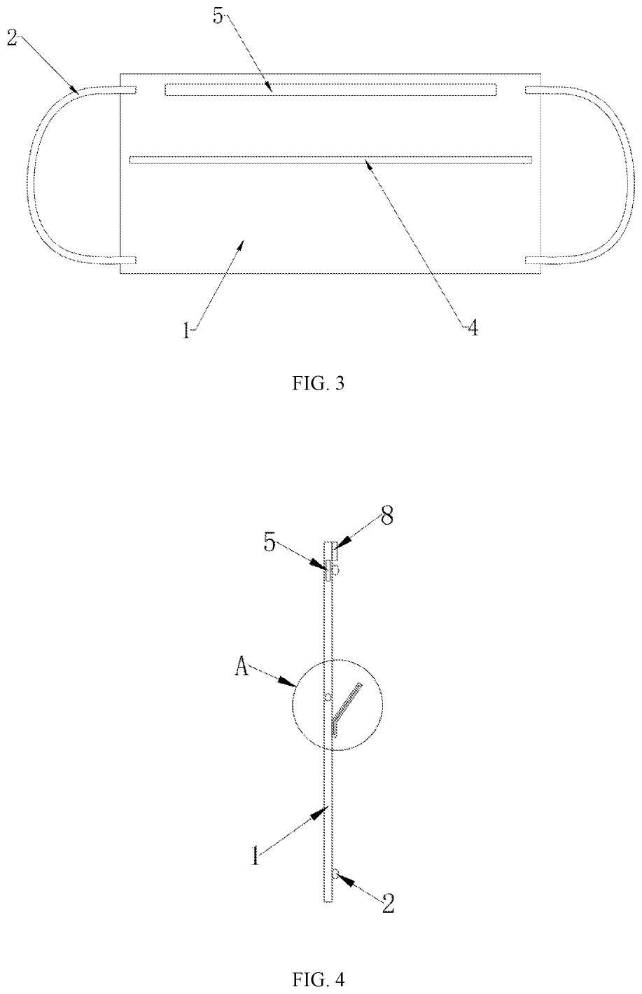

As illustrated in FIG. 1 through FIG. 6, a mask capable of blocking air flows between a mouth and a nose may include a mask body 1. Left and right ends of the mask body 1 are fixedly connected to a pair of ear ropes 2. A rear surface of the mask body 1 is fixedly connected with a blocking sheet 3. A tightening rope 4 penetrates transversely through an inner cavity of the mask body 1. The tightening rope 4 is arranged on an upper side of the blocking sheet 3. A nose bridge strip 5 is fixedly connected in the inner cavity of the mask body 1, and the nose bridge strip 5 is arranged on an upper side of the tightening rope 4. A shaping sheet 6 is fixedly connected in an inner cavity of the blocking sheet 3. This embodiment can provide a blocking between the mouth and the nose through the blocking sheet 3 and press tightly through the tightening rope 4 to prevent peculiar smell emitted from the mouth from flowing into a nasal cavity when a user wears the mask, and thus comfort of the user wearing the mask can be improved. Moreover, by setting a sealing strip 8, a sealing between the mask and the nose bridge when wearing the mask can be enhanced, so that exhaled hot air can be prevented from flowing to glasses worn by the user, and a usage experience of a myopic person wearing the mask in winter can be improved.

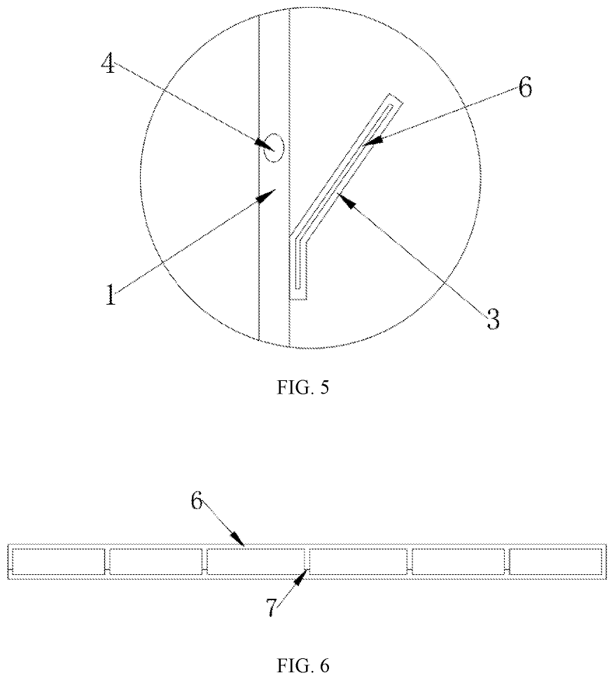

As shown in FIG. 5 and FIG. 6, the shaping sheet 6 may be made of an aluminium alloy material. By setting the shaping sheet 6 made of the aluminium alloy material, it is convenient to bend, and when the mask is worn, the mask can be bent along a crease 7, and the blocking sheet 3 is shaped by bending the shaping sheet 6, so that the blocking sheet 3 can be tightly attached to an upper lip of a user, good blocking between the mouth and the nose can be achieved, and air flows between the mouth and the nose can be avoided consequently. The crease 7 is disposed on a rear surface of the shaping sheet 6, and the crease 7 is located at a quarter position and a lower end of the shaping sheet 6. By setting the crease 7, it is convenient to bend the shaping sheet 6.

As shown in FIG. 2 and FIG. 4, the rear surface of the mask body 1 may be fixedly connected with the sealing strip 8. The sealing strip 8 is located on an upper side of the nose bridge strip 5. The sealing strip 8 may be made of a slow-rebound sponge material. By setting the sealing strip 8 made of slow-rebound sponge material, a degree of fitting between the mask and the nose bridge when the mask is worn can be enhanced; and when wearing the mask in winter, exhaled hot air can be prevented from flowing to glasses worn by the user, and a usage experience of a myopic person wearing the mask in winter can be improved.

As shown in FIG. 1 through FIG. 3, the mask body 1 may be made of a non-woven fabric and a filter paper material. By setting the mask body 1 made of the non-woven fabric and the filter paper material, the mask body 1 may have certain air permeability while blocking germs and droplets.

In an illustrated embodiment of the invention, first the shaping sheet 6 is bent along the crease 7 to make the blocking sheet 3 form a certain angle relative to the mask body 1; then the shaping sheet 6 is transversely bent to make the blocking sheet 3 fit a curve of a user's face as much as possible; afterwards the ear ropes 2 are stretched and put on the ears; subsequently the tightening rope 4 is used to press the blocking sheet 3 tightly, and then the nose bridge strip 5 is pressed to make it fit a curve of the user's nose as much as possible, thereby completing the wearing of the mask. Compared with the prior art, the embodiments of the invention can provide a blocking between the mouth and the nose through the blocking sheet 3 and press tightly through the tightening rope 4 to prevent peculiar smell emitted from the mouth from flowing into a nasal cavity when a user wears the mask, and thus comfort of the user wearing the mask can be improved. Moreover, by setting the sealing strip 8, a sealing between the mask and the nose bridge when wearing the mask can be enhanced, so that exhaled hot air can be prevented from flowing to glasses worn by the user, and a usage experience of a myopic person wearing the mask in winter can be improved.

The above description is only preferred concrete embodiments of the invention, and the scope of protection of the invention is not limited to this. Any equivalent substitution or modification made by those skilled in the art according to the technical solutions of the embodiments of the invention and their improvement concepts within the technical scope disclosed by the embodiments of the invention shall be covered by the scope of protection of the invention.

What is claimed is:

1. A mask capable of blocking air flows between a mouth and a nose, comprising a mask body (1); wherein left and right ends of the mask body (1) are fixedly connected with a pair of ear ropes (2), a rear surface of the mask body (1) is fixedly connected with a blocking sheet (3), a tightening rope (4) penetrates transversely through an inner cavity of the mask body (1), the tightening rope (4) is arranged on an upper side of the blocking sheet (3), a nose bridge strip (5) is fixedly connected in the inner cavity of the mask body (1), the nose bridge strip (5) is arranged on an upper side of the tightening rope (4), and a shaping sheet (6) is fixedly connected in an inner cavity of the blocking sheet (3).

2. The mask as claimed in claim 1, wherein the shaping sheet (6) is made of an aluminum alloy material.

3. The mask as claimed in claim 1, wherein a crease (7) is formed at a rear surface of the shaping sheet (6), and the crease (7) is located at a quarter position and a lower end of the shaping sheet (6).

4. The mask as claimed in claim 1, wherein the rear surface of the mask body (1) is fixedly connected with a sealing strip (8), the sealing strip (8) is arranged on an upper side of the nose bridge strip (5), and the sealing strip (8) is made of a sponge material.

5. The mask as claimed in claim 1, wherein the mask body (1) is made of a non-woven fabric and a filter paper material.

6. A mask comprising:
a mask body (1);
a pair of ear ropes (2), wherein left and right ends of the mask body (1) are fixedly connected with a pair of ear ropes (2);
a nose bridge strip (5), fixedly connected in an inner cavity of the mask body (1); and
a sealing strip (8), fixedly connected to a rear surface of the mask body (1), wherein the sealing strip (8) is arranged on an upper side of the nose bridge strip (5) and the sealing strip (8) is configured to prevent exhaled air from flowing to glasses worn by a user of wearing the mask.

7. The mask as claimed in claim 6, wherein the mask further comprises:
a blocking sheet (3), fixedly connected to the rear surface of the mask body (1);
a shaping sheet (6), fixedly connected in an inner cavity of the blocking sheet (3); and
a tightening rope (4), penetrating transversely through the inner cavity of the mask body (1), wherein the tightening rope (4) is configured to press the blocking sheet (3), and the nose bridge strip (5) is arranged on an upper side of the tightening rope (4).
